(19) United States
(12) Patent Application Publication
(10) Pub. No.: US 2026/0239352 A1
(43) Pub. Date: Aug. 13, 2026

(54) CONFIGURED GRANT OPERATION

(71) Applicant: Nokia Technologies Oy, Espoo (FI)

(72) Inventors: Margarita GAPEYENKO, Espoo (FI); Chunli WU, Beijing (CN); Jorma Johannes KAIKKONEN, Oulu (FI)

(21) Appl. No.: 19/154,251

(22) PCT Filed: Feb. 16, 2023
(86) PCT No.: PCT/CN2023/076543

§ 371 Date: Aug. 6, 2025

(51) Int. Cl. H04W 72/21; H04W 72/115

(52) U.S. Cl. CPC H04W 72/21; H04W 72/115

(57) ABSTRACT

Embodiments of the present disclosure relate to CG operation. In one aspect, a terminal device transmits, to a network device, an indication indicating that at least one first occasion configured by a configured grant configuration is not to be used. The terminal device determines that at least one second occasion configured by the configured grant configuration for a first uplink transmission overlaps with at least one occasion for a second up-link transmission. The at least one first occasion is subsequent to the at least one second occasion. Based on the determination, the terminal device re-activates the at least one first occasion for the first uplink transmission.

### FIELD

Various example embodiments relate to the field of telecommunication and in particular, to a method, device, apparatus and computer readable storage medium of communication for configured grant (CG) operation.

### BACKGROUND

Scheduling in uplink (UL) may be realized by employing CG. For CG based scheduling, the parameters are configured via Radio Resource Control (RRC) message. The actual uplink grant may either be configured via RRC message or provided via physical downlink control channel (PDCCH) addressed to configured scheduling-radio network temporary identifier (CS-RNTI).

When user equipment (UE) deems that UL buffer does not have further video frames to be transmitted, UE may indicate to gNB that CG occasions associated with the UL video are not used till new video frame arrives to the buffer. However, in some cases, UE will need the CG occasions previously indicated to be unused.

### SUMMARY

In general, example embodiments of the present disclosure provide a solution of communication for CG operation.

In a first aspect, there is provided a terminal device. The terminal device comprises at least one processor; and at least one memory storing instructions that, when executed by the at least one processor, cause the terminal device at least to: transmit, to a network device, an indication indicating that at least one first occasion configured by a configured grant configuration is not to be used; determine that at least one second occasion configured by the configured grant configuration for a first uplink transmission overlaps with at least one occasion for a second uplink transmission, the at least one first occasion being subsequent to the at least one second occasion; and based on the determination, re-activate the at least one first occasion for the first uplink transmission.

In a second aspect, there is provided a network device. The network device comprises at least one processor; and at least one memory storing instructions that, when executed by the at least one processor, cause the network device at least to: receive, from a terminal device, an indication indicating that at least one first occasion configured by a configured grant configuration is not to be used; determine that at least one second occasion configured by the configured grant configuration for a first uplink transmission overlaps with at least one occasion for a second uplink transmission, the at least one first occasion being subsequent to the at least one second occasion; and based on the determination, re-activate the at least one first occasion for reception of the first uplink transmission.

In a third aspect, there is provided a method implemented at a terminal device. The method comprises: transmitting, from a terminal device to a network device, an indication indicating that at least one first occasion configured by a configured grant configuration is not to be used; determining that at least one second occasion configured by the configured grant configuration for a first uplink transmission overlaps with at least one occasion for a second uplink transmission, the at least one first occasion being subsequent to the at least one second occasion; and based on the determination, re-activating the at least one first occasion for the first uplink transmission.

In a fourth aspect, there is provided a method implemented at a network device. The method comprises: receiving, at a network device from a terminal device, an indication indicating that at least one first occasion configured by a configured grant configuration is not to be used; determining that at least one second occasion configured by the configured grant configuration for a first uplink transmission overlaps with at least one occasion for a second uplink transmission, the at least one first occasion being subsequent to the at least one second occasion; and based on the determination, re-activating the at least one first occasion for reception of the first uplink transmission.

In a fifth aspect, there is provided an apparatus. The apparatus comprises: means for transmitting, from a terminal device to a network device, an indication indicating that at least one first occasion configured by a configured grant configuration is not to be used; means for determining that at least one second occasion configured by the configured grant configuration for a first uplink transmission overlaps with at least one occasion for a second uplink transmission, the at least one first occasion being subsequent to the at least one second occasion; and means for re-activating the at least one first occasion for the first uplink transmission based on the determination.

In a sixth aspect, there is provided an apparatus. The apparatus comprises: means for receiving, at a network device from a terminal device, an indication indicating that at least one first occasion configured by a configured grant configuration is not to be used; means for determining that at least one second occasion configured by the configured grant configuration for a first uplink transmission overlaps with at least one occasion for a second uplink transmission, the at least one first occasion being subsequent to the at least one second occasion; and means for re-activating the at least one first occasion for reception of the first uplink transmission based on the determination.

In a seventh aspect, there is provided a non-transitory computer readable medium comprising program instructions that, when executed by an apparatus, cause the apparatus to perform at least the method according to the third or fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which embodiments of the present disclosure may be implemented;

FIG. 2 illustrates a signaling chart illustrating a process for CG operation in accordance with some embodiments of the present disclosure;

FIGS. 3A and 3B illustrate an example implementation of uplink transmission via CG resources in accordance with some example embodiments of the present disclosure, respectively;

FIG. 4 illustrates a flowchart of an example method implemented at a terminal device according to some embodiments of the present disclosure;

FIG. 5 illustrates a flowchart of an example method implemented at a network device according to some embodiments of the present disclosure;

FIG. 6 illustrates a simplified block diagram of a device that is suitable for implementing embodiments of the present disclosure; and

FIG. 7 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) next generation NodeB (also referred to as a gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting Radio Resource Control (RRC), Service Data Adaptation Protocol (SDAP) and Packet Data Convergence Protocol (PDCP)) controlling a plurality of gNB-DUs (Distributed unit, hosting Radio Link Control (RLC), Medium Access Control (MAC) and Physical layer (PHY)).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

Extended reality (XR) refers to all real-and-virtual combined environments and associated human-machine interactions generated by computer technology and wearables. XR includes representative forms such as augmented reality (AR), mixed reality (MR), and virtual reality (VR) and the areas interpolated among them.

The main video traffic characteristics in uplink (UL) related to XR may be summarized as follows: a non-integer periodicity (e.g., 16.6 ms for 60 fps); a packet delay budget (PDB) requirement of 30 ms as baseline and 10 ms and 15 ms as optional; a varying video frame size with mean 20.8 kBytes for 60 fps and 10 Mbit/s following Truncated Gaussian distribution.

In addition to video in UL, pose or control information can be sent with the following main characteristics: a periodicity of 4 ms; a stringent PDB requirement of 10 ms; a frame size of 100 bytes.

Scheduling in UL may be realized by employing CG. For CG based scheduling, the parameters are configured via RRC message. The actual uplink grant may either be configured via RRC message (type1) or provided via PDCCH addressed to configured scheduling-radio network temporary identifier (CS-RNTI) (type2).

The main characteristics of NR Release 16 UL CG may comprise at least one of the following: UL radio resources for sending one transport block with a regular time-periodicity is configured for a UE; the periodicities are 2, 7, or n*14 symbols, where the range for n depends on configured subcarrier spacing (SCS); or up to 12 configured grant configurations per bandwidth part (BWP) (configured through RRC signaling).

XR enhancements were motivated by large and variable video size in UL that in many cases require more than one slot to be transmitted. For certain XR applications such as AR, there could be different traffic in UL: (i) pose/control every 4 ms and (ii) video every 16.67 ms for 60 fps. The PDB for pose/control is equal to 10 ms and for UL video is 30 ms and optional is 10 or 15 ms. One of the enhancements considered for specification work is dynamic indication of unused CG occasion(s). This is especially needed when video is transmitted with CG resources and one video frame is conveyed via multiple UL slots. In that case, multiple CG occasions (such as slots) per CG period is assumed. However, due to variable video frame size, not all CG occasions might be used in one period. In order to improve resource utilization, UE may indicate that certain CG occasions are not used. In that case, gNB can distribute the released resources to another user. To be able to distribute the resources, the indication of unused resources has to arrive well in advance at gNB side.

When UE deems that UL buffer does not have further video frames to be transmitted, it is assumed that UE will indicate to gNB that CGs associated with the UL video are not needed till new video frame arrives to the buffer. This indication could be picky-packed to the CG containing the data of the video frame or provided with uplink control information (UCI) on physical uplink control channel (PUCCH) for example. However, if some of the transmission fails, it will require a retransmission. If retransmission collides with scheduled CG resources, the retransmission will be transmitted first and new data has to be postponed. In that case, UE will need the earlier de-activated CG occasions.

Embodiments of the present disclosure provide a solution for CG operation. In this solution, a terminal device transmits, to a network device, an indication indicating that at least one first occasion configured by a configured grant configuration is not to be used. The terminal device determines that at least one second occasion configured by the configured grant configuration for a first uplink transmission overlaps with at least one occasion for a second uplink transmission. The at least one first occasion is subsequent to the at least one second occasion. Based on the determination, the terminal device re-activates the at least one first occasion for the first uplink transmission. In this way, fast re-activation of one or more CG occasions may reduce delay of data transmission.

Principles and implementations of the present disclosure will be described in detail below with reference to the figures.

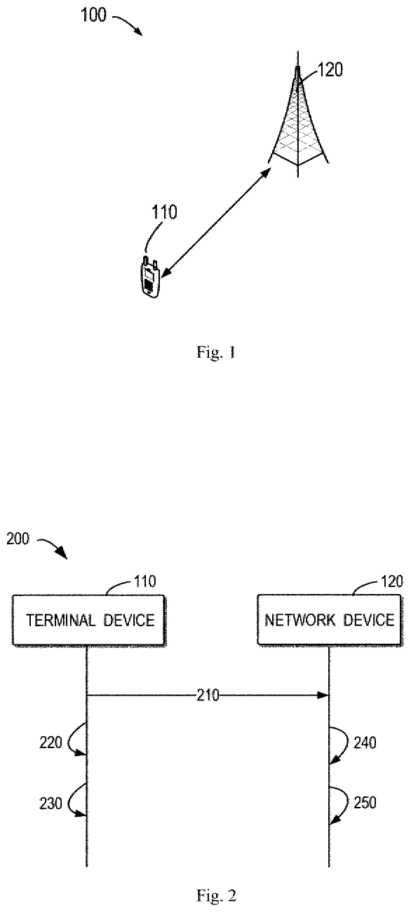

FIG. 1 illustrates a schematic diagram of an example communication environment 100 in which some embodiments of the present disclosure can be implemented. As shown in FIG. 1, the communication environment 100 may include a terminal device 110 and a network device 120 serving the terminal device 110.

It is to be understood that the numbers of terminal devices and network devices in FIG. 1 is given for the purpose of illustration without suggesting any limitations to the present disclosure. The communication environment 100 may include any suitable number of terminal devices and/or network devices adapted for implementing implementations of the present disclosure.

As shown in FIG. 1, the terminal device 110 and the network device 120 may communicate with each other via a wireless communication channel. The communications within the communication environment 100 may conform to any suitable standard including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) or the sixth generation (6G) communication protocols.
FIG. 2 illustrates a signaling chart illustrating a process 200 for CG operation in accordance with some embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the terminal device 110 transmits 210, to the network device 120, an indication indicating that at least one first occasion configured by a configured grant configuration is not to be used.

In some example embodiments, the terminal device 110 may transmit the indication in UCI.

Accordingly, the network device 120 received the indication from the terminal device 110.

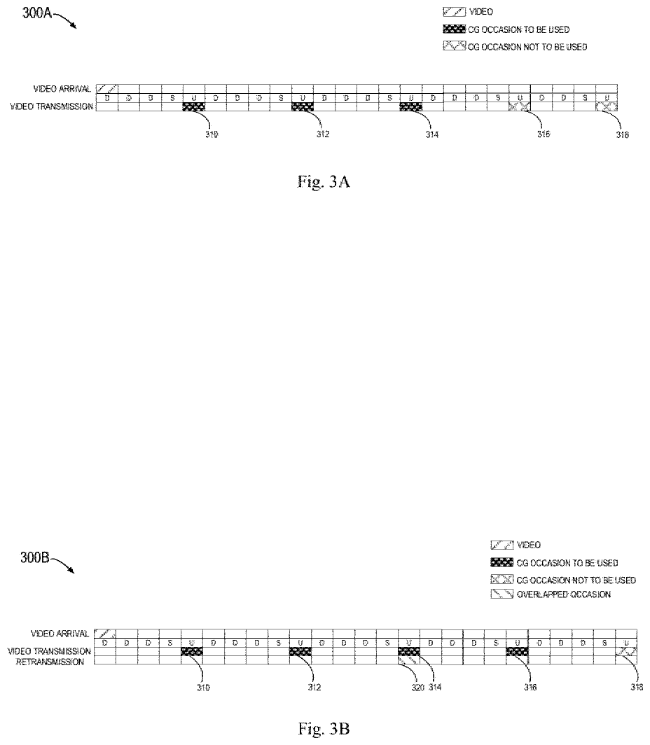

FIG. 3A illustrates an example implementation 300A of uplink transmission via CG resources in accordance with some example embodiments of the present disclosure. In this example implementation 300A, it is assumed that a time division duplexing (TDD) pattern is DDDSU and SCS is equal to 30 kHz. Video traffic is sent using CG resources. CG occasions 310, 312, 314, 316 and 318 may be configured by a CG configuration for a first uplink transmission of the video traffic. For example, the CG occasions 310, 312, 314, 316 and 318 may be configured for one or more CG periods.

Based on the data available for transmission in a buffer of the terminal device 110, the terminal device 110 transmits, to the network device 120, an indication indicating that the CG occasions 316 and 318 are not to be used. Thus, the CG occasions 316 and 318 may be deactivated. For example, the terminal device 110 may transmit the indication in the beginning of the CG occasion 310.

Return to FIG. 2. The terminal device 110 determines 220 that at least one second occasion configured by the CG configuration for the first uplink transmission overlaps with at least one occasion for a second uplink transmission. The at least one first occasion is subsequent to the at least one second occasion.

Based on the determination, the terminal device 110 re-activates 230 the at least one first occasion for the first uplink transmission. In turn, the terminal device 110 may perform the first uplink transmission to the network device 120 in the at least one first occasion.

Similarly, the network device 120 determines 240 that at least one second occasion configured by the CG configuration for the first uplink transmission overlaps with at least one occasion for a second uplink transmission.

Based on the determination, the network device 120 re-activates 250 the at least one first occasion for the first uplink transmission. In turn, the network device 120 may receive the first uplink transmission from the terminal device 110 in the at least one first occasion.

With the process 200, fast re-activation of CG configuration(s) may reduce delay of data transmission.

In some example embodiments, alternatively or additionally, the indication indicating that the at least one first occasion is not to be used may indicate the number of occasions required for the first uplink transmission instead of indicating which occasions in the CG configuration are used. The network device 120 may determine which occasions in the CG configuration are used for the first uplink transmission based on the indication and the determination that the at least one second occasion overlaps with the at least one occasion for a second uplink transmission. Thus, it is not always the first X occasions used or the last Y occasions not used. The terminal device 110 does not need to explicitly indicate which occasions in the CG configuration are used or not as it is dynamic depending on the determination that the at least one second occasion overlaps with the at least one occasion for a second uplink transmission.

It is to be noted that the above process 200 is merely an example, and may have additional or less operations. It is also to be noted that operations of the above process 200 may be carried out separately or in any suitable combination.

FIG. 3B illustrates an example implementation 300B of uplink transmission via CG resources in accordance with other example embodiments of the present disclosure. The CG configuration in the example implementation 300B is similar to that in the example implementation 300A.

However, in the example implementation 300B, the CG occasion 314 configured by the CG configuration for the first uplink transmission overlaps with an occasion 320 for a second uplink transmission. Thus, the CG occasion 314 will not be able to be used for the first uplink transmission. Instead, the terminal device 110 may re-activate the CG occasion 316 which was indicated to be unused. In turn, the terminal device 110 may use the CG occasion 316 for the first uplink transmission.

Similarly, the network device 120 may determine that the CG occasion 314 overlaps with the occasion 320. Thus, based on the indication and the determination that the CG occasion 314 overlaps with the occasion 320, the network device 120 may determine that the CG occasion 314 will not be able to be used for the first uplink transmission. In turn, the network device 120 may re-activate the CG occasion 316 which was indicated to be unused. Then, the network device 120 may use the CG occasion 316 for reception of the first uplink transmission.

In some example embodiments, the second uplink transmission may be a retransmission of the first uplink transmission. Such example embodiments will be described with reference to FIGS. 3A and 3B.

As shown in FIG. 3A, the terminal device 110 transmits, to the network device 120, an indication indicating that the CG occasions 316 and 318 are not to be used.

For example, if the first uplink transmission in the CG occasion 310 is not received correctly by the network device 120, the network device 120 may transmit a dynamic grant to the terminal device 110. The dynamic grant may indicate the occasion 320 for a retransmission of the first uplink transmission in the CG occasion 310, as shown in FIG. 3B.

Based on the CG configuration and the dynamic grant, the terminal device 110 and the network device 120 may determine that the CG occasion 314 for the first uplink transmission overlaps with the occasion 320 for the retransmission.

In turn, the terminal device 110 and the network device 120 may re-activate the CG occasion 316 for the first uplink transmission. For example, the terminal device 110 and the network device 120 may implicitly assume that the CG occasion 316 is re-activated again when the network device 120 dynamically schedules the retransmission during the occasion 320.

In some example embodiments, the terminal device 110 may re-activate the CG occasion 316 upon receiving the dynamic grant from the network device 120. Accordingly, the network device 120 may re-activate the CG occasion 316 upon transmitting the dynamic grant to the terminal device 110.

Then, the terminal device 110 may use the CG occasion 316 to perform the first uplink transmission.

In the above example embodiments, more reasonable design of UCI indication for usage of CG occasions may be achieved, which depends on the actual usable CG occasions taking the overlapping dynamic grant into account.

In some example embodiments, the second uplink transmission may be a pending retransmission associated with the configured grant configuration. Such example embodiments will be described with reference to FIGS. 3A and 3B.

The terminal device 110 transmits, to the network device 120, an indication indicating that the CG occasions 316 and 318 are not to be used.

Upon performing the first uplink transmission in the CG occasion 310, the terminal device 110 may start a timer. If the timer expires before the CG occasion 314 and the terminal device 110 does not receive any Hybrid Automatic Repeat Request (HARQ) feedback information for the first uplink transmission in the CG occasion 310, the terminal device 110 may determine that there is a pending retransmission associated with the configured grant configuration. Additionally, or alternatively, the terminal device 110 may determine that the CG occasion 314 for the first uplink transmission overlaps with the occasion 320 for the pending retransmission.

In turn, the terminal device 110 and the network device 120 may re-activate the CG occasion 316 for the first uplink transmission. For example, the terminal device 110 and the network device 120 may cancel the indication indicating that the CG occasion 316 is not to be used.

In some example embodiments, the second uplink transmission may be an initial transmission. In such example embodiments, the at least one occasion for the second uplink transmission may indicated by a dynamic grant for the initial transmission.

In some example embodiments, the dynamic grant for the initial transmission may be used to perform the first uplink transmission. For example, the dynamic grant for the initial transmission may be used to transmit data in the buffer of the terminal device 110. In such example embodiments, the terminal device 110 may not re-activate the at least one first occasion subsequent to the at least one second occasion. However, if a resource indicated by the dynamic grant does not accommodate as much data as the CG occasion, the terminal device 110 needs to re-activate the at least one first occasion subsequent to the at least one second occasion. Alternatively, or additionally, if logic channel prioritization (LCP) restrictions indicate that the resource indicated by the dynamic grant cannot be used to transmit the data in the buffer, the terminal device 110 needs to re-activate the at least one first occasion subsequent to the at least one second occasion.

In some example embodiments, the second uplink transmission may be a pending initial transmission. In such example embodiments, if the terminal device 110 determines that the CG occasion 314 overlaps with the occasion 320 for the pending initial transmission, the terminal device 110 and the network device 120 may re-activate the CG occasion 316 for the first uplink transmission.

In some example embodiments, if the network device 120 determines that the first uplink transmission is correctly received in all of the at least one second occasion, the network device 120 may allocate the at least one first occasion to a further terminal device. Such example embodiments will be described with reference to FIGS. 3A and 3B.

As shown in FIG. 3A, the terminal device 110 transmits, to the network device 120, an indication indicating that the CG occasions 316 and 318 are not to be used.

Only after the first uplink transmission in the last CG occasion 312 in FIG. 3B is correctly received by the network device 120, the network device 120 may allocate the CG occasions 316 and 318 to a further terminal device. The further terminal device is different from the terminal device 110.

If the first uplink transmission in at least one of the CG occasions 310 and 312 are not correctly received, the terminal device 110 and the network device 120 may re-activate at least one of the CG occasions 316 and 318.

It shall be understood that in above example embodiments, it is assumed that the first uplink transmission in a single previous CG occasion (for example, the CG occasion 314) is postponed to a single subsequent CG occasion (for example, the CG occasion 316). In some other example embodiments, the first uplink transmission in multiple previous CG occasions (for example, the CG occasions 312 and 314) may be postponed to multiple subsequent CG occasions (for example, the CG occasions 316 and 318). In such example embodiments, the number of the multiple subsequent CG occasions to be re-activated is equal to the number of the multiple previous CG occasions.

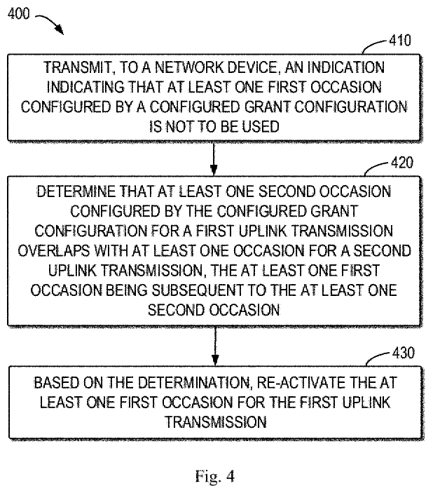

FIG. 4 illustrates a flowchart of an example method 400 implemented at a terminal device according to some embodiments of the present disclosure. For the purpose of discussion, the method 400 will be described with reference to FIG. 1.

At block 410, the terminal device 110 transmits, to a network device, an indication indicating that at least one first occasion configured by a configured grant configuration is not to be used.

At block 420, the terminal device 110 determines that at least one second occasion configured by the configured grant configuration for a first uplink transmission overlaps with at least one occasion for a second uplink transmission. The at least one first occasion is subsequent to the at least one second occasion.

At block 430, based on the determination, the terminal device 110 re-activates the at least one first occasion for the first uplink transmission.

With the method 400, fast re-activation of CG configuration(s) may reduce delay of data transmission.

In some example embodiments, the second uplink transmission is one of the following: a retransmission of the first uplink transmission, or an initial transmission.

In some example embodiments, the at least one occasion for the second uplink transmission is indicated by a dynamic grant for the retransmission or the initial transmission.

In some example embodiments, re-activating the at least one first occasion comprises: re-activating the at least one first occasion upon receiving the dynamic grant from the network device.

In some example embodiments, determining that the at least one second occasion overlaps with the at least one occasion for the second uplink transmission comprises at least one of the following: determining that there is at least one pending retransmission associated with the configured grant configuration; determining that the at least one second occasion overlaps with the at least one occasion for the at least one pending retransmission; or determining that the at least one second occasion overlaps with the at least one occasion for the at least one pending initial transmission.

In some example embodiments, the number of the at least one second occasion is equal to the number of the at least one first occasion.

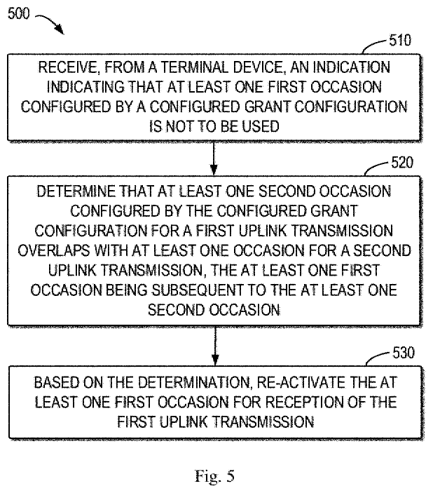

FIG. 5 illustrates a flowchart of an example method 500 implemented at a network device according to some embodiments of the present disclosure. For the purpose of discussion, the method 500 will be described with reference to FIG. 1.

At block 510, the network device 120 receives, from a terminal device, an indication indicating that at least one first occasion configured by a configured grant configuration is not to be used.

At block 520, the network device 120 determines that at least one second occasion configured by the configured grant configuration for a first uplink transmission overlaps with at least one occasion for a second uplink transmission. The at least one first occasion being subsequent to the at least one second occasion.

At block 530, based on the determination, the network device 120 re-activates the at least one first occasion for reception of the first uplink transmission.

With the method 500, fast re-activation of CG configuration(s) may reduce delay of data transmission.

In some example embodiments, the second uplink transmission is one of the following: a retransmission of the first uplink transmission, or an initial transmission.

In some example embodiments, the at least one occasion for the second uplink transmission is indicated by a dynamic grant for the retransmission or the initial transmission.

In some example embodiments, re-activating the at least one first occasion comprises: re-activating the at least one first occasion upon transmitting the dynamic grant to the terminal device.

In some example embodiments, determining that the at least one second occasion overlaps with the at least one occasion for the second uplink transmission comprises at least one of the following: determining that there is at least one pending retransmission associated with the configured grant configuration; determining that the at least one second occasion overlaps with the at least one occasion for the at least one pending retransmission; or determining that the at least one second occasion overlaps with the at least one occasion for the at least one pending initial transmission.

In some example embodiments, the number of the at least one second occasion is equal to the number of the at least one first occasion.

In some example embodiments, the method 500 further comprises: based on determining that the first uplink transmission is correctly received in all of the at least one second occasion, allocating the at least one first occasion to a further terminal device.

It is to be noted that details of the embodiments described with reference to FIGS. 2, 3A and 3B are also applicable to the methods 400 and 500. The details are omitted for brevity.

Example embodiments of the present disclosure also provide the corresponding apparatus. In some example embodiments, an apparatus (for example, the terminal device 110) capable of performing the method 400 may comprise means for performing the respective steps of the method 400. The means may be implemented in any suitable form. For example, the means may be implemented in a circuitry or software module.

In some example embodiments, the apparatus comprises: means for transmitting, from a terminal device to a network device, an indication indicating that at least one first occasion configured by a configured grant configuration is not to be used; means for determining that at least one second occasion configured by the configured grant configuration for a first uplink transmission overlaps with at least one occasion for a second uplink transmission, the at least one first occasion being subsequent to the at least one second occasion; and means for re-activating the at least one first occasion for the first uplink transmission based on the determination.

In some example embodiments, the second uplink transmission is one of the following: a retransmission of the first uplink transmission, or an initial transmission.

In some example embodiments, the at least one occasion for the second uplink transmission is indicated by a dynamic grant for the retransmission or the initial transmission.

In some example embodiments, the means for re-activating the at least one first occasion comprises: means for re-activating the at least one first occasion upon receiving the dynamic grant from the network device.

In some example embodiments, the means for determining that the at least one second occasion overlaps with the at least one occasion for the second uplink transmission comprises at least one of the following: means for determining that there is at least one pending retransmission associated with the configured grant configuration; means for determining that the at least one second occasion overlaps with the at least one occasion for the at least one pending retransmission; or means for determining that the at least one second occasion overlaps with the at least one occasion for the at least one pending initial transmission.

In some example embodiments, the number of the at least one second occasion is equal to the number of the at least one first occasion.

In some example embodiments, an apparatus (for example, the network device 120) capable of performing the method 500 may comprise means for performing the respective steps of the method 500. The means may be implemented in any suitable form. For example, the means may be implemented in a circuitry or software module.

In some example embodiments, the apparatus comprises: means for receiving, at a network device from a terminal device, an indication indicating that at least one first occasion configured by a configured grant configuration is not to be used; means for determining that at least one second occasion configured by the configured grant configuration for a first uplink transmission overlaps with at least one occasion for a second uplink transmission, the at least one first occasion being subsequent to the at least one second occasion; and means for re-activating the at least one first occasion for reception of the first uplink transmission based on the determination.

In some example embodiments, the second uplink transmission is one of the following: a retransmission of the first uplink transmission, or an initial transmission.

In some example embodiments, the at least one occasion for the second uplink transmission is indicated by a dynamic grant for the retransmission or the initial transmission.

In some example embodiments, the means for re-activating the at least one first occasion comprises: means for re-activating the at least one first occasion upon transmitting the dynamic grant to the terminal device.

In some example embodiments, the means for determining that the at least one second occasion overlaps with the at least one occasion for the second uplink transmission comprises at least one of the following: means for determining that there is at least one pending retransmission associated with the configured grant configuration; means for determining that the at least one second occasion overlaps with the at least one occasion for the at least one pending retransmission; or means for determining that the at least one second occasion overlaps with the at least one occasion for the at least one pending initial transmission.

In some example embodiments, the number of the at least one second occasion is equal to the number of the at least one first occasion.

In some example embodiments, the apparatus further comprises: based on determining that the first uplink transmission is correctly received in all of the at least one second occasion, means for allocating the at least one first occasion to a further terminal device.

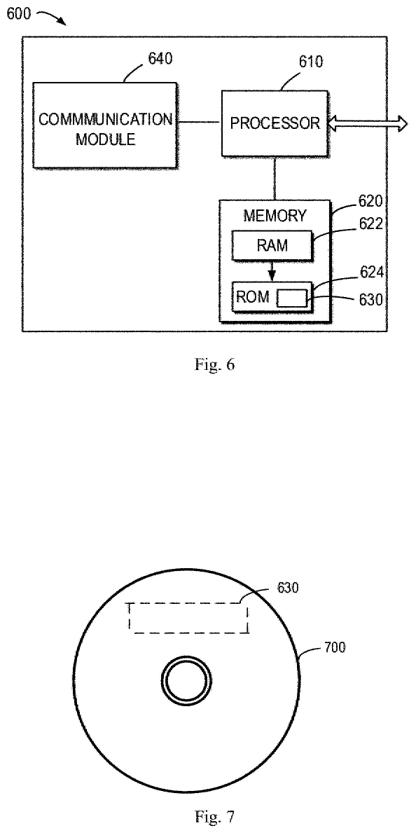

FIG. 6 is a simplified block diagram of a device 600 that is suitable for implementing embodiments of the present disclosure. The device 600 may be provided to implement the communication device, for example the terminal device 110 or the network device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 1 to 5. The embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 4 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-16. (canceled)

17. A terminal device, comprising:
at least one processor; and
at least one memory storing instructions that, when executed by the at least one processor, cause the terminal device at least to:
transmit, to a network device, an indication indicating that at least one first occasion configured by a configured grant configuration is not to be used;
determine that at least one second occasion configured by the configured grant configuration for a first uplink transmission overlaps with at least one occasion for a second uplink transmission, the at least one first occasion being subsequent to the at least one second occasion; and
based on the determination, re-activate the at least one first occasion for the first uplink transmission.

18. The terminal device of claim 17, wherein the second uplink transmission is one of the following:
a retransmission of the first uplink transmission, or
an initial transmission.

19. The terminal device of claim 18, wherein the at least one occasion for the second uplink transmission is indicated by a dynamic grant for the retransmission or the initial transmission.

20. The terminal device of claim 19, wherein the terminal device is caused to re-activate the at least one first occasion upon receiving the dynamic grant from the network device.

21. The terminal device of claim 18, wherein the terminal device is caused to determine that the at least one second occasion overlaps with the at least one occasion for the second uplink transmission by at least one of the following:
determining that there is at least one pending retransmission associated with the configured grant configuration;
determining that the at least one second occasion overlaps with the at least one occasion for the at least one pending retransmission; or
determining that the at least one second occasion overlaps with the at least one occasion for the at least one pending initial transmission.

22. The terminal device of claim 17, wherein the number of the at least one second occasion is equal to the number of the at least one first occasion.

23. A network device, comprising:
at least one processor; and
at least one memory storing instructions that, when executed by the at least one processor, cause the network device at least to:
receive, from a terminal device, an indication indicating that at least one first occasion configured by a configured grant configuration is not to be used;
determine that at least one second occasion configured by the configured grant configuration for a first uplink transmission overlaps with at least one occasion for a second uplink transmission, the at least one first occasion being subsequent to the at least one second occasion; and
based on the determination, re-activate the at least one first occasion for reception of the first uplink transmission.

24. The network device of claim 23, wherein the second uplink transmission is one of the following:
a retransmission of the first uplink transmission, or
an initial transmission.

25. The network device of claim 24, wherein the at least one occasion for the second uplink transmission is indicated by a dynamic grant for the retransmission or the initial transmission.

26. The network device of claim 25, wherein the network device is caused to re-activate the at least one first occasion upon transmitting the dynamic grant to the terminal device.

27. The network device of claim 24, wherein the network device is caused to determine that the at least one second occasion overlaps with the at least one occasion for the second uplink transmission by at least one of the following:
determining that there is at least one pending retransmission associated with the configured grant configuration; determining that the at least one second occasion overlaps with the at least one occasion for the at least one pending retransmission; or
determining that the at least one second occasion overlaps with the at least one occasion for the at least one pending initial transmission.

28. The network device of claim 23, wherein the number of the at least one second occasion is equal to the number of the at least one first occasion.

29. The network device of claim 23, wherein the network device is further caused to:
based on determining that the first uplink transmission is correctly received in all of the at least one second occasion, allocate the at least one first occasion to a further terminal device.

30. A method, comprising:
transmitting, from a terminal device to a network device, an indication indicating that at least one first occasion configured by a configured grant configuration is not to be used;
determining that at least one second occasion configured by the configured grant configuration for a first uplink transmission overlaps with at least one occasion for a second uplink transmission, the at least one first occasion being subsequent to the at least one second occasion; and
based on the determination, re-activating the at least one first occasion for the first uplink transmission.

31. The method of claim 30, wherein the second uplink transmission is one of the following:
a retransmission of the first uplink transmission, or
an initial transmission.

32. The method of claim 31, wherein the at least one occasion for the second uplink transmission is indicated by a dynamic grant for the retransmission or the initial transmission.

33. The method of claim 32, re-activating the at least one first occasion, upon receiving the dynamic grant from the network device.

34. The method of claim 31, determining that the at least one second occasion overlaps with the at least one occasion for the second uplink transmission by at least one of the following:
determining that there is at least one pending retransmission associated with the configured grant configuration;
determining that the at least one second occasion overlaps with the at least one occasion for the at least one pending retransmission; or
determining that the at least one second occasion overlaps with the at least one occasion for the at least one pending initial transmission.

35. The terminal device of claim 30, wherein the number of the at least one second occasion is equal to the number of the at least one first occasion.
